(19) United States
(12) Patent Application Publication
(10) Pub. No.: US 2001/0012582 A1
(43) Pub. Date: Aug. 9, 2001

(54) Prismatic sealed battery and method for making the same

(76) Inventor: Young-hoon Kim, Cheonan-city (KR)

Correspondence Address: LEYDIG VOIT & MAYER, LTD, 700 THIRTEENTH ST. NW, SUITE 300, WASHINGTON, DC, 20005-3960, US

(21) Appl. No.: 09/748,126

(22) Filed: Dec. 27, 2000

(30) Foreign Application Priority Data
Dec. 27, 1999 (KR) 99-62627

(51) Int. Cl. H01M 2/06; H01M 2/30

(52) U.S. Cl. 429/184; 429/176; 29/623.2; 29/623.4

(57) ABSTRACT

Provided are a prismatic type sealed battery suitable for enhancing a tightly sealing capability between a case and a leading terminal connected from the inside of the case to the outside of the case and simplifying the structure of the battery, and a method for making the same. The prismatic type sealed battery includes a case consisting of a can accommodating a positive electrode, a negative electrode and an electrolytic solution, and a cap plate welded to an opening of the can and sealed, a leading terminal insert-connected to a throughhole of the cap plate to then be led outside, and a fluoride resin injected between the leading terminal and the throughhole of the cap plate for insulation and sealing both elements. The leading terminal includes a head and a connecting portion inserted into the throughhole of the cap plate. The leading terminal is connected to one of the positive and negative electrodes and the case is electrically connected to the other electrode.

### BACKGROUND OF THE INVENTION

1. Field of the Invention

The present invention relates to a prismatic type sealed battery suitable for enhancing a tightly sealing capability between a case and a leading terminal connected from the inside of the case to the outside of the case and simplifying the structure of the battery, and a method for making the same.

2. Description of the Related Art

A sealed battery is capable of recharging and achieving miniaturization, and has a large capacity. Typical sealed batteries currently being used include nickel-metal hydride (Ni—MH) batteries, lithium (Li) batteries and Li-ion batteries. Sealed batteries are classified into cylindrical batteries and prismatic batteries according to the appearance type.

FIG. 1 shows the structure of a conventional prismatic type sealed battery.

As shown in the drawing, the conventional prismatic type sealed battery is constructed such that an electrode group 2 is formed by laminating a positive electrode, a negative electrode and a separator sandwiched therebetween, followed by winding them together, the electrode group 2 is housed in a can 4, a cap plate 6 is welded to an upper opening of the can 4, a leading terminal 8 penetrating the cap plate 6 to be led outside, is fixed and hermetically sealed by a gasket 10 and an insulation plate 12, and a terminal plate 14 is installed between the lower portion of the leading terminal 8 and the insulation plate 12.

The negative electrode of the electrode group 2 is electrically connected by direct contact with the can 4 or by means of a terminal tab (not shown), and the positive electrode is connected with the leading terminal 8 through the terminal plate 14 welded to a terminal tab 16 to then be connected to the outside of the battery.

Here, the leading terminal 8 physically fastens the cap plate 6, the gasket 10, the insulation plate 12 and the terminal plate 14, and serves as an electrical terminal connected to the outside of the battery. To this end, the leading terminal 8 is inserted downwardly from the above of the cap plate 6, and is then insulated by disposing the insulation plate 12 and the gasket 10 made of polyethylene or polypropylene, to then be coupled to the lower side of the terminal plate 14 by riveting or cocking.

However, according to the aforementioned prismatic type sealed battery, a tightly sealing capability may become poor between the leading terminal 8 and the cap plate 6. The poor tightly sealing capability results from weak and lowered bonding strength by the leading terminal 8. That is, in order to ensure a tightly sealing capability, the compression ratio of the gasket 10 by the leading terminal 8 should be maintained at 30 to 50%. However, in the case of forming the leading terminal 8 using aluminum for attaining a light-weight battery, the bonding strength of the leading terminal 8 is reduced, resulting in inferiority of a tightly sealing capability.

The inferiority of a tightly sealing capability may also be caused by thermal deformation of the injection-molded gasket 10 and insulation plate 12 when heat is applied like in welding of the can 4 and the cap plate 6. The insulation plate 12 and the gasket 10 made of polyethylene or polypropylene having a low melting point, that is, 120 to 130° C., are very vulnerable to thermal deformation.

The inferior tightly sealing capability causes leakage of electrolyte, which is harmful to the human and shortens the lifetime of a battery.

Also, according to the conventional sealed battery, a complex construction is required for connecting and sealing the leading terminal 8 and the cap plate 6, the assembling thereof is a difficult work, and the manufacturing cost increases.

Under the circumstances, conventional technology has been proposed as disclosed, for example, in U.S. Pat. No. 6,042,961 entitled “Sealed One Piece Battery Having a Prism Shape Container” and U.S. Pat. No. 6,132,900 entitled “Method of Production of Non-aqueous Electrolytic Battery and Seal Plate Thereof:” However, means for solving the above-described problems are not disclosed in these patents.

### SUMMARY OF THE INVENTION

To solve the above problems, it is an object of the present invention to solve the inferiority of a sealing capability and to simplify the construction of assembly components.

To achieve the above object, the present invention proposes a prismatic type sealed battery in which fluoride resin having adhesiveness is filled between a cap plate and a leading terminal for insulating both elements from each other, to then be fixed to each other and sealed.

In more detail, the prismatic type sealed battery includes a case having a can for accommodating a power generating element and a cap plate connected to an opening of the can, a leading terminal connected to one electrode of the power generating element and inserted into an opening of the cap plate to then be led outside, a fluoride resin, filled between the leading terminal and the case, for insulating the leading terminal and the case from each other and sealing, wherein another electrode of the power generating element is electrically connected to the case.

Preferably, the leading terminal includes a head and a connecting portion inserted into the opening of the case and is formed of one material selected from the group consisting of aluminum, a nickel alloy and a nickel plated material. The fluoride resin is one selected from the group consisting of fluorocarbon, tetrafluoroethylene-perfluoroalkylvinyl ether copolymer and polytetrafluoroethylene.

As a method for making the prismatic type sealed battery having the above-described configuration, the present invention provides a method including the steps of arranging the leading terminal such that a connecting portion thereof penetrates a throughhole of the cap plate to be led outside and disposing a mask on the cap plate, electrostatic-coating fluoride resin powder between the leading terminal and the cap plate, and heating, curing the fluoride resin powder to then be sealed.

Also, in the present invention, preferably, the electrostatic-coating of the fluoride resin powder is repeatedly performed at least two times. Also, the manufacturing method may further include the step of primarily electrostatic-coating polytetrafluoroethylene powder, before electrostatic-coating the fluoride resin powder.

### BRIEF DESCRIPTION OF THE DRAWINGS

The above object and advantages of the present invention will become more apparent by describing in detail a preferred embodiment thereof with reference to the attached drawings in which:

FIG. 1 is a cross-sectional view of a conventional prismatic type sealed battery;

FIG. 2 is an exploded perspective view of a prismatic type sealed battery according to the present invention;

FIG. 3 is a cross-sectional view of the prismatic type sealed battery according to the present invention; and

FIG. 4 is a diagram for explaining a method for making the prismatic type sealed battery according to the present invention.

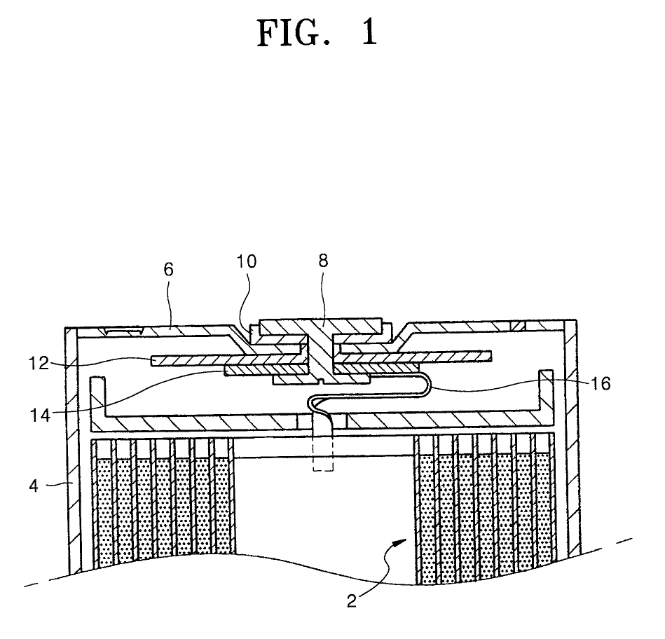

### DESCRIPTION OF THE PREFERRED EMBODIMENT

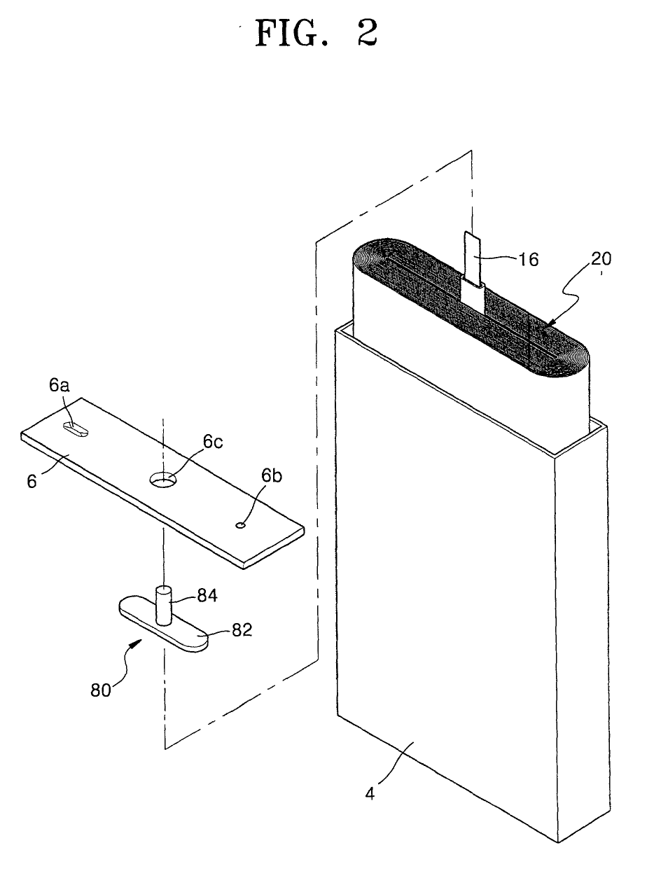

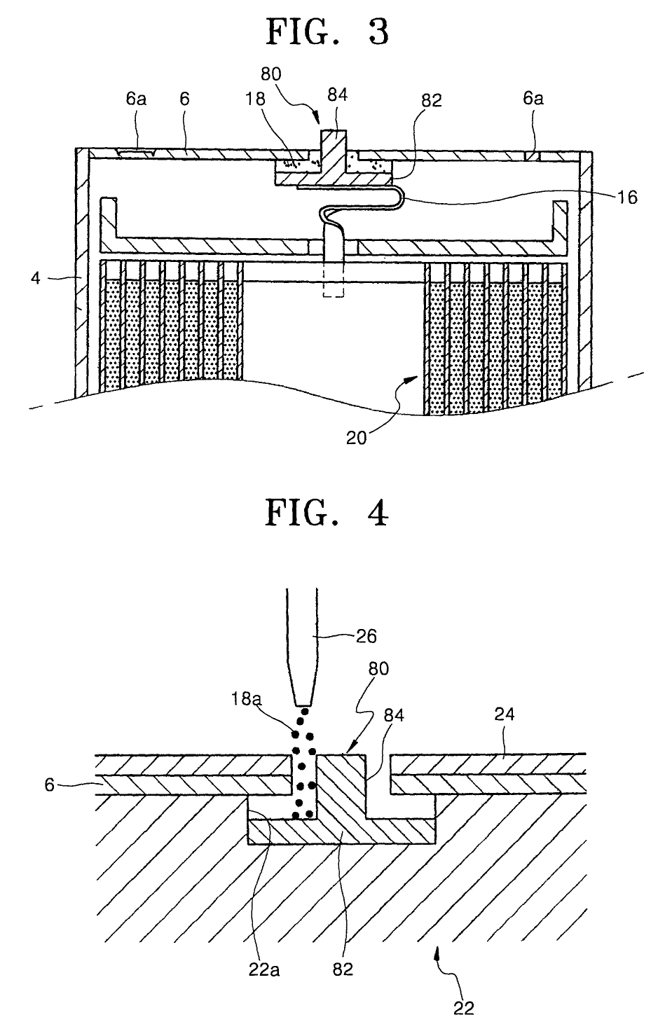

FIGS. 2 and 3 are an exploded perspective view and a cross-sectional view of a prismatic type sealed battery according to the present invention. In the present invention, a lithium (ion) battery capable of charging and discharging by migration of lithium ions is illustrated by way of example. The same elements as those of conventional battery are denoted by the same reference numerals.

Referring to the drawings, the prismatic type sealed battery according to the present invention includes, in view of external appearance, a prismatic type case consisting of a can 4 and a cap plate 6 welded to an upper opening of the can 4 and sealed.

The can 4 accommodates a power generating element 20 having a positive electrode, a negative electrode, a separator for insulating the positive and negative electrodes from each other, and an electrolytic solution. The electrolytic solution is injected into the inside of the can 4 through an electrolytic solution injection hole 6a after connecting the cap plate 6, and then the injection hole 6a is sealed using a separate plug.

A leading terminal 80 is insert-connected to the cap plate 6 through a central throughhole 6c, a fluoride resin 18 is injected between the leading terminal 80 and the throughhole 6c of the cap plate 6 for insulation, and then fixed and sealed.

The leading terminal 80 includes a head 82 having a circular, elliptic or rectangular shape, and a connecting portion 84 extending from the head 82. In a state in which the connecting portion 84 is inserted upwardly from the lower portion of the cap plate 6, the connecting portion 84 is sealed by the fluoride resin 18, to form a cap assembly.

Here, one among fluorocarbon, tetrafluoroethylene-perfluoroalkylvinyl ether copolymer and polytetrafluoroethylene can be used as the fluoride resin 18. These fluoride resins have a considerably higher firing temperature compared to the conventional insulation plate and gasket inject-molded at 300 to 400° C. Thus, a high-temperature characteristic of preventing thermal deformation during a subsequent process, e.g., a process of welding the can 4 and the cap plate 6, can be attained. Also, since the fluoride resin 18 has a chemical resistance against an electrolytic solution and has good adhesion between metals, it can be advantageously used as an adhesive agent of the cap plate 6 and the leading terminal 80.

The aforementioned prismatic type sealed battery according to the present invention can prevent a bonding strength between a cap plate and a leading terminal from being weakened, unlike the conventional battery in which the bonding strength between a cap plate and a leading terminal is weakened by the leading terminal based on a riveting or cocking method. As a result, the sealing capability can be maintained at the same level even by using aluminum, a nickel alloy or a nickel plated material as the material of the leading terminal 80. Here, the case can be formed of the same material as that of the leading terminal 80.

Thus, in the present invention, copper, brass, aluminum, a nickel alloy, a nickel plated material and other metallic materials can be used for forming the leading terminal 80.

Also, according to the present invention, the configuration of a battery can be simplified, thereby improving the assembling operation efficiency and productivity, unlike the prior art.

The leading terminal 80 of the present invention is welded to a tab 16 led from the positive electrode of the power generating element 20 to be used as a positive electrode terminal. Also, the case of the battery is connected to the negative electrode of the power generating element 20 by means of a tab (not shown) or through direct contact to be used as a negative electrode terminal. Here, the leading terminal 80 and the case can be used as opposite polar terminals.

The cap plate 6 of the present invention includes a safety valve 6b as a safety measure against abnormal operation of a battery or an increase of an internal pressure, which can be realized by forming a groove by a physical method or by punching a throughhole in the cap plate 6 and then hermetically sealing the throughhole using a thin plate.

A method for making the prismatic type sealed battery according to the present invention will now be described with reference to FIG. 4.

In the present invention, before welding the cap plate 6 to the opening of the can 4, the leading terminal 80 connected to the positive electrode of the power generating element 20 is coupled to the throughhole 6c of the cap plate 6 and sealed.

To this end, in the present invention, the connecting portion 84 of the leading terminal 80 is arranged using a zig 22 such that it penetrates the throughhole 6c of the cap plate 6 to then be led outside. Here, the leading terminal 80 is inserted into a concave portion 22a of the zig 22 and a mask 24 is disposed on the cap plate 6.

Subsequently, fluoride resin powder 187a is electrostatic-coated on a space between the leading terminal 80 and the cap plate 6 using a spray nozzle 26. Here, one among fluorocarbon, tetrafluoroethylene-perfluoroalkylvinyl ether copolymer and polytetrafluoroethylene is used as the fluoride resin powder 18a, and the electrostatic coating is repeatedly performed to form a multi-layered stack. For example, when the gap between the leading terminal 80 and the cap plate 6 is 0.1 mm, the electrostatic coating is performed 5 times by 20 μm each time or twice by 50 μm each time.

Also, in the present invention, in order to improve the coating efficiency of the fluoride resin powder 18a filled between the leading terminal 80 and the cap plate 6, polytetrafluoroethylene powder may be primarily electrostatic-coated to a thickness of 20 μm before electrostatic-coating the fluoride resin powder 18a.

Thereafter, the fluoride resin powder 18a filled between the leading terminal 80 and the cap plate 6 is heated at 300 to 400° C. and cured to then be sealed. The heating and curing are preferably performed at least two times for the purpose of improving the tightly sealing capability.

The thus-formed cap plate 6 is welded to the opening of the can 4 accommodating the power generating element 20, thereby forming the prismatic type sealed battery according to the present invention.

As described above, in the prismatic type sealed battery according to the present invention and the method for making the same, a cap plate and a leading terminal are insulated from, fixed to each other and sealed using a fluoride resin having a good high-temperature characteristic. Thus, the sealing capability and assembling operation efficiency can be improved and leakage of an electrolytic solution can be prevented, thereby enhancing the reliability of a completed product. Also, according to the present invention, since the construction of fixing and sealing the leading terminal and the cap plate is simplified, thereby improving the assembling efficiency and productivity.

While the invention has been described in terms of a specific embodiment, the description of the present invention is intended to be illustrative and it will be apparent to one of ordinary skill in the art that various changes and equivalent embodiments can be made therein without departing from the spirit and scope thereof.

What is claimed is:

1. A prismatic type sealed battery, comprising:
a case for accommodating and hermetically sealing a power generating element;
a leading terminal connected to one electrode of the power generating element and inserted into an opening of the case to then be led outside; and
a fluoride resin, filled between the leading terminal and the case, for insulating the leading terminal and the case from each other and sealing, wherein another electrode of the power generating element is electrically connected to the case.

2. The prismatic type sealed battery according to claim 1, wherein the case includes a prismatic type can, and a cap plate, welded to the opening of the can, having a throughhole.

3. The prismatic type sealed battery according to claim 1, wherein the leading terminal includes a head and a connecting portion inserted into the opening of the case.

4. The prismatic type sealed battery according to claim 1, wherein the leading terminal is formed of one material selected from the group consisting of aluminum, a nickel alloy and a nickel plated material.

5. The prismatic type sealed battery according to claim 1, wherein the case is formed of one material selected from the group consisting of aluminum, a nickel alloy and a nickel plated material.

6. The prismatic type sealed battery according to claim 1, wherein the fluoride resin is one selected from the group consisting of fluorocarbon, tetrafluoroethylene-perfluoroalkylvinyl ether copolymer and polytetrafluoroethylene.

7. A method for making a prismatic type sealed battery in which a leading terminal connected to one electrode of a power generating element is fixed to a cap plate to be fixed to an opening of a can, and sealed, the method comprising the steps of:
arranging the leading terminal such that a connecting portion thereof penetrates a throughhole of the cap plate to be led outside and disposing a mask on the cap plate;
electrostatic-coating fluoride resin powder between the leading terminal and the cap plate; and
heating, curing the fluoride resin powder to then be sealed.

8. The method according to claim 7, wherein the fluoride resin powder is one selected from the group consisting of fluorocarbon, tetrafluoroethylene-perfluoroalkylvinyl ether copolymer and polytetrafluoroethylene.

9. The method according to claim 7, wherein the electrostatic-coating of the fluoride resin powder is repeatedly performed at least two times.

10. The method according to claim 7, further comprising the step of primarily electrostatic-coating polytetrafluoroethylene powder, before electrostatic-coating the fluoride resin powder.

11. The method according to claim 7, wherein the heating temperature of the fluoride resin powder is 300 to 400° C.

12. The method according to claim 7, wherein the step of heating and curing the fluoride resin powder is repeatedly performed at least two times.
